(19) United States
(12) Patent Application Publication
(10) Pub. No.: US 2025/0123718 A1
(43) Pub. Date: Apr. 17, 2025

(54) ILLUMINATED TOUCHPAD

(71) Applicant: Acer Incorporated, New Taipei City (TW)

(72) Inventors: Yi-Jung Chiu, New Taipei City (TW); Wei-Kuo Shih, New Taipei City (TW)

(73) Assignee: Acer Incorporated, New Taipei City (TW)

(21) Appl. No.: 18/515,276

(22) Filed: Nov. 21, 2023

(30) Foreign Application Priority Data
Oct. 17, 2023 (TW) 112139495

(51) Int. Cl. G06F 3/042; G09G 3/3208

(52) U.S. Cl. CPC G06F 3/042; G09G 3/3208; G06F 2203/04107; G09G 2354/00

(57) ABSTRACT

An illuminated touchpad including a protection layer, a touch module, a lens array layer and a light source module is provided. The touch module is disposed between the protection layer and the lens array layer. The lens array layer is disposed between the touch module and the light source module. The light source module is configured to generate a plurality of illuminated patterns. Lights of the illuminated patterns pass through the lens array layer, the touch module and the protection layer to form a plurality of stereoscopic images.

### CROSS-REFERENCE TO RELATED APPLICATION

This application claims the priority benefit of Taiwan application serial no. 112139495, filed on Oct. 17, 2023. The entirety of each of the above-mentioned patent applications is hereby incorporated by reference herein and made a part of this specification.

### BACKGROUND

### Technical Field

The disclosure relates to a touchpad, and in particular to an illuminated touchpad.

### Description of Related Art

The touchpad has a wide range of applications in electronic products. For example, the touchpad can be used on a smartphone to allow a user to quickly perform setting actions or open setting applications. Alternatively, the touchpad can be used in a notebook computer to replace the mouse function.

In order to further improve the convenience of the touchpad, application icons can be set on the touchpad. When the application icon is touched, the system may open the corresponding application. However, for users, the touchpad currently on the market still has room for improvement in design.

### SUMMARY

The present disclosure provides an illuminated touchpad that can provide intuitive operation functions.

An embodiment of the present disclosure provides an illuminated touchpad, which includes a protection layer, a touch module, a lens array layer and a light source module. The touch module is disposed between the protection layer and the lens array layer. The lens array layer is disposed between the touch module and the light source module. The light source module is configured to generate a plurality of illuminated patterns. Lights of the illuminated patterns pass through the lens array layer, the touch module and the protection layer to form a plurality of stereoscopic images.

Based on the above, in an embodiment of the present disclosure, the illuminated touchpad is configured to generate a plurality of illuminated patterns by the light source module, and the lights of the illuminated patterns pass through the lens array layer, the touch module and the protection layer to form a plurality of stereoscopic images. Therefore, the system may display the stereoscopic images by emitting light, so that the user may still operate the illuminated touchpad in a low-illumination environment. Moreover, the system may use the stereoscopic images to present operable actions or openable applications, thereby further improving the user's adaptability to using the illuminated touchpad.

### BRIEF DESCRIPTION OF THE DRAWINGS

FIG. 1 is a schematic diagram of an illuminated touchpad applied to an electronic device according to an embodiment of the present disclosure.

FIG. 2 is a schematic cross-sectional view of the illuminated touchpad according to an embodiment of the present disclosure.

FIG. 3 is a schematic diagram of a viewing angle of the stereoscopic images of the illuminated touchpad according to an embodiment of the present disclosure.

FIG. 4 is a schematic diagram of the illuminated touchpad according to an embodiment of the present disclosure.

FIG. 5 is a schematic cross-sectional view of the illuminated touchpad according to an embodiment of the present disclosure.

### DESCRIPTION OF THE EMBODIMENTS

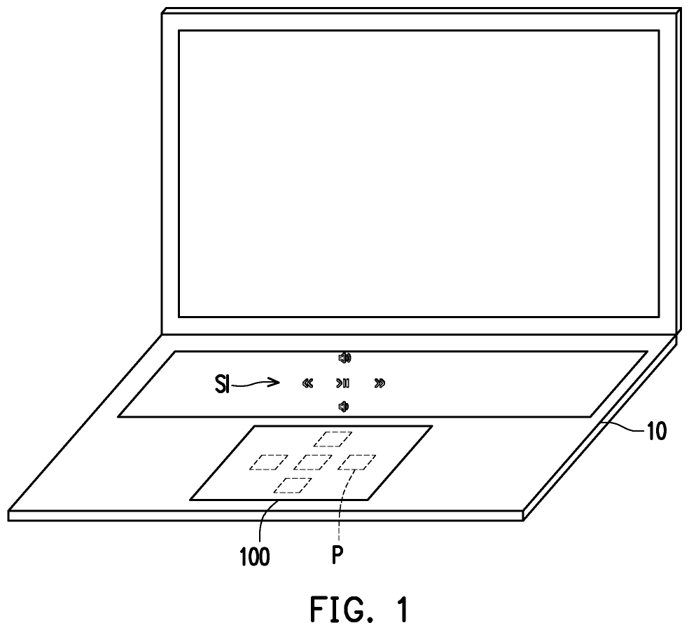

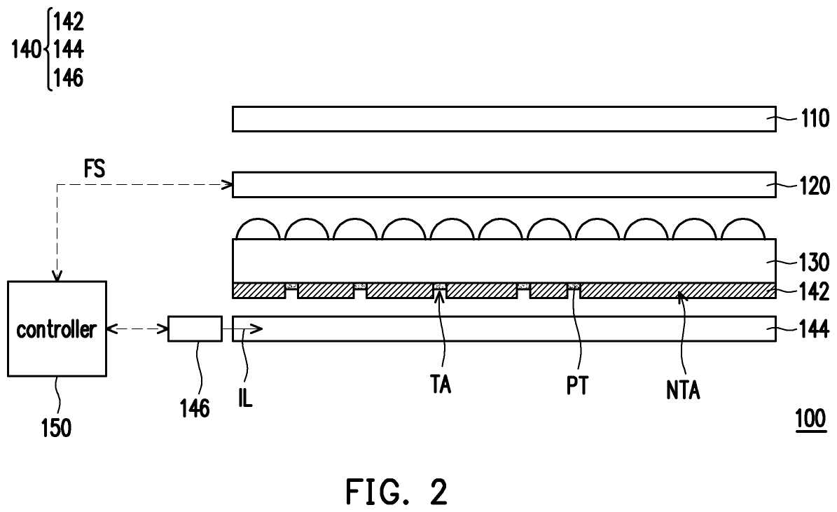

FIG. 1 is a schematic diagram of an illuminated touchpad applied to an electronic device according to an embodiment of the present disclosure. FIG. 2 is a schematic cross-sectional view of the illuminated touchpad according to an embodiment of the present disclosure. Referring to FIG. 1 and FIG. 2, an embodiment of the present disclosure provides an illuminated touchpad 100, which is applied to an electronic device 10. The electronic device 10 is, such as a notebook computer, a smart phone or a keyboard, but the present disclosure is not limited thereto.

In the embodiment, the illuminated touchpad 100 includes a protection layer 110, a touch module 120, a lens array layer 130 and a light source module 140. The protection layer 110 is, for example, a flat plate made of transparent materials such as plastic and glass. In one embodiment, the protection layer 110 may be a light-transmitting flat plate that has been atomized.

In the embodiment, the touch module 120 is disposed between the protection layer 110 and the lens array layer 130. The lens array layer 130 is disposed between the touch module 120 and the light source module 140. The light source module 140 is configured to generate a plurality of illuminated patterns. Lights of the illuminated patterns pass through the lens array layer 130, the touch module 120 and the protection layer 110 to form a plurality of stereoscopic images SI.

In details, in the embodiment, the light source module 140 includes a pattern layer 142, a light-guiding layer 144 and a light source 146. The pattern layer 142 is disposed on one side of the lens array layer 130 relative to the touch module 120. The pattern layer 142 is disposed between the lens array layer 130 and the light-guiding layer 144. The pattern layer 142 includes a plurality of patterns PT. The pattern layer 142 has a light-transmitting area TA and a non-light-transmitting area NTA, and the patterns PT are disposed in the light-transmitting area TA.

For example, the non-light-transmitting area NTA can be black opaque ink. Alternatively, the color of the non-light-transmitting area NTA may be the same as the color of the electronic device 10, thereby making the illuminated touchpad 100 visually consistent with the electronic device 10 when not illuminated.

In the embodiment, the light source 146 is, for example, a light-emitting diode (LED) light source or other suitable light source. The light source 146 is disposed next to the light-guiding layer 144 and configured to emit an illumination beam IL. The light-guiding layer 144 is, for example, a light-guiding film or a light-guiding plate. The illumination beam IL is first transmitted to the light-guiding layer 144, and then transmitted to the patterns PT through the light-guiding layer 144 to generate the illuminated patterns. That is to say, when the illumination beam IL is transmitted to the pre-designed patterns PT to generate the illuminated patterns, the illuminated patterns are transmitted to the left eye or right eye of the viewer through the lens array layer 130, thereby giving the viewer the visual effect of seeing the stereoscopic images SI. Taking FIG. 1 as an example, the stereoscopic images SI can be played, forward, backward, volume up, volume down, etc. In another embodiment, the stereoscopic images SI can also be presented in the form of text.

In order to improve the visual consistency between the illuminated touchpad 100 and the electronic device 10 when not illuminated, in the embodiment, the light transmittance of the light-transmitting area TA is preferably less than 70%.

In the embodiment, the illuminated touchpad 100 further includes a controller 150. The controller 150 is electrically connected to the touch module 120 and the light source module 140. The controller 150 controls the light source module 140 to generate the illuminated patterns, and generates a corresponding functional signal FS when a position P corresponding to the stereoscopic images SI on the illuminated touchpad 100 (the protection layer 110) is touched.

In the embodiment, the controller 150 includes, for example, a Microcontroller Unit (MCU), a central processing unit (CPU), a microprocessor, a digital signal processor (DSP), a programmable controller, a programmable logic device (PLD) or other similar devices or combinations of these devices, but the present disclosure is not limited thereto. Furthermore, in on embodiment, each function of the controller 150 can be implemented as multiple program codes. These program codes can be stored in a memory and executed by the controller 150. Alternatively, in one embodiment, the functions of the controller 150 may be implemented as one or more circuits. The present disclosure is not limited to using software or hardware to implement each function of the controller 150.

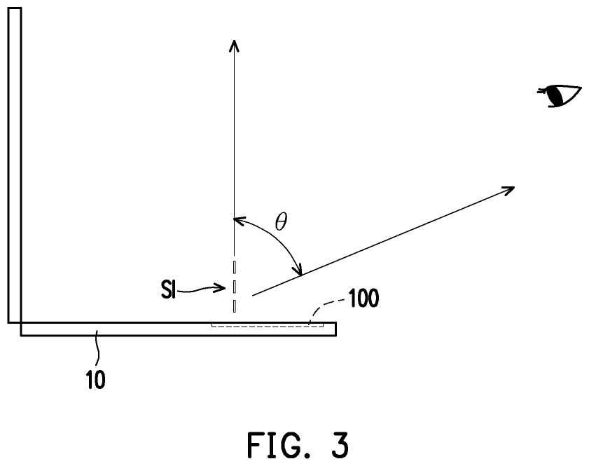

FIG. 3 is a schematic diagram of a viewing angle of the stereoscopic images of the illuminated touchpad according to an embodiment of the present disclosure. Referring to FIG. 3, in the embodiment, the viewing angle θ of the stereoscopic images SI is less than or equal to 60 degrees.

Based on the above, in one embodiment of the present disclosure, the illuminated touchpad 100 includes the protection layer 110, the touch module 120, the lens array layer 130 and the light source module 140. The light source module 140 is configured to generate a plurality of illuminated patterns, and the lights of the illuminated patterns pass through the lens array layer 130, the touch module 120 and the protection layer 110 to form a plurality of the stereoscopic images SI. Therefore, the system can display the stereoscopic images SI by emitting light, so that the user can still operate the illuminated touchpad 100 in a low-illumination environment. Moreover, the system can use the stereoscopic images SI to present operable actions or openable applications, thereby further improving the user's adaptability to using the illuminated touchpad 100.

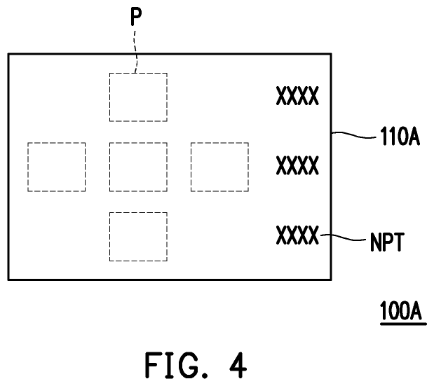

FIG. 4 is a schematic diagram of the illuminated touchpad according to an embodiment of the present disclosure. Referring to FIG. 4, the illuminated touchpad 100A is similar to the illuminated touchpad 100 of FIG. 2, with the main differences being as follows. In the embodiment, the protection layer 110A has a plurality of non-illuminated patterns NPT on one side relative to the touch module 120. When the position corresponding to the non-illuminated patterns NPT on the illuminated touchpad 100A (the protection layer 110A) is touched, the controller 150 generates the corresponding function signal FS. For example, the non-illuminated patterns NPT can be icons or names of commonly used applications (such as browsers, computer software, video software, etc.). When the user touches the non-illuminated patterns NPT, the system can open the corresponding application.

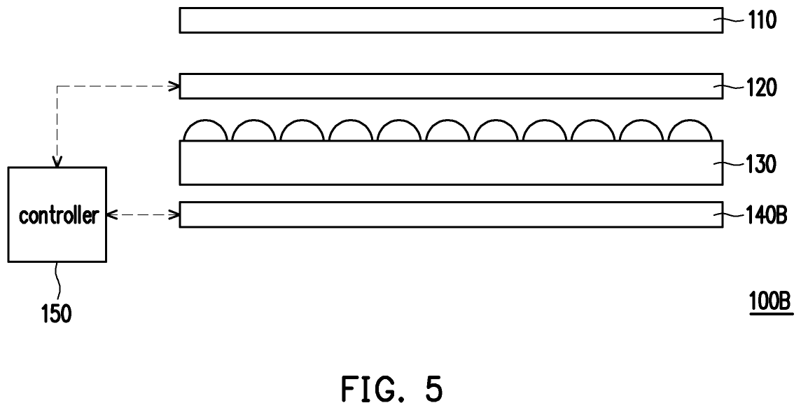

FIG. 5 is a schematic cross-sectional view of the illuminated touchpad according to an embodiment of the present disclosure. Referring to FIG. 5, the illuminated touchpad 100B is similar to the illuminated touchpad 100 of FIG. 2 or the illuminated touchpad 100A of FIG. 4, with the main differences being as follows. In the embodiment, the light source module 140B is a display module, such as a liquid crystal display, an Organic Light Emitting Diode (OLED) display, etc. That is to say, the display module can directly generate the illuminated patterns. Therefore, the system can change the stereoscopic images SI generated by the illuminated touchpad 100B by changing the illuminated patterns; or, the stereoscopic images SI generated by the illuminated touchpad 100B can change depending on the applications opened in the system.

In summary, in an embodiment of the present disclosure, the illuminated touchpad includes a protection layer, a touch module, a lens array layer and a light source module. The light source module is configured to generate a plurality of illuminated patterns. Lights of the illuminated patterns pass through the lens array layer, the touch module and the protection layer to form a plurality of stereoscopic images. Therefore, the system can display the stereoscopic images by emitting light, so that the user can still operate the illuminated touchpad in a low-illumination environment. Moreover, the system can use the stereoscopic images to present operable actions or openable applications, thereby further improving the user's adaptability to using the illuminated touchpad.

1. An illuminated touchpad, comprising:
a protection layer;
a touch module;
a lens array layer, wherein the touch module is disposed between the protection layer and the lens array layer, and the protection layer has a plurality of non-illuminated patterns on one side relative to the touch module; and
a light source module, wherein the lens array layer is disposed between the touch module and the light source module, the light source module is configured to generate a plurality of illuminated patterns, lights of the illuminated patterns pass through the lens array layer, the touch module and the protection layer to form a plurality of stereoscopic images.

2. The illuminated touchpad according to claim 1, further comprises:
a controller, electrically connected to the touch module and the light source module,
wherein the controller controls the light source module to generate the illuminated patterns, and generates a corresponding functional signal when a position corresponding to the stereoscopic images on the illuminated touchpad is touched.

3. The illuminated touchpad according to claim 1, wherein a viewing angle of the stereoscopic images is less than or equal to 60 degrees.

4. The illuminated touchpad according to claim 1, wherein the light source module comprises:
a pattern layer, disposed on one side of the lens array layer relative to the touch module, and comprises a plurality of patterns;
a light-guiding layer, wherein the pattern layer is disposed between the lens array layer and the light-guiding layer; and
a light source, disposed next to the light-guiding layer and configured to emit an illumination beam,
wherein the illumination beam is first transmitted to the light-guiding layer, and then transmitted to the patterns through the light-guiding layer to generate the illuminated patterns.

5. The illuminated touchpad according to claim 4, wherein the pattern layer has a light-transmitting area and a non-light-transmitting area, the patterns are disposed in the light-transmitting area.

6. The illuminated touchpad according to claim 5, wherein a light transmittance of the light-transmitting area is less than 70%.

7. The illuminated touchpad according to claim 1, wherein the light source module is a display module.

8. (canceled)

9. The illuminated touchpad according to claim 1, further comprises:
a controller, electrically connected to the touch module,
wherein when a position corresponding to the non-illuminated patterns on the illuminated touchpad is touched, the controller generates a corresponding functional signal.
